(19) United States
(12) Patent Application Publication
(10) Pub. No.: US 2008/0140238 A1
(43) Pub. Date: Jun. 12, 2008

(54) Method for Playing and Processing Audio Data of at Least Two Computer Units

(76) Inventor: Manfred Rurup, Hamburg (DE)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/815,999

(22) PCT Filed: Feb. 10, 2006
(86) PCT No.: PCT/EP2006/001252

§ 371 Date: Oct. 9, 2007

(30) Foreign Application Priority Data
Feb. 12, 2005 (DE) 102005006487.6

(51) Int. Cl. G06F 17/00

(52) U.S. Cl. 700/94

(57) ABSTRACT

A method for playing and processing of audio data by at least two computers over a packet switching data network, wherein at least one first computer receives audio data via an audio input and further transmits it to the second computer, the audio data of the first computer is provided with consecutive sample numbers, which relate to the starting time, wherein the starting time is set by the first computer, in that a copy of the start of the further audio data is transmitted to the first computer and the starting time of the audio data of the first computer is defined relative to the starting time of the further audio data, a second computer is initialized for playing the further audio data, which is similarly provided with a consecutive sample number, the audio data is buffered in a storage and assigned to each other using the sample numbers.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention relates to a method for playing and processing audio data by at least two computers over a packet switching network.

From DE 697 10 569 T2, the entire contents of which is incorporated herein by reference, a method is known for the real time playing of music with a client server structure (multiple node structure). For so-called MIDI data, the method proposes to provide control data for the creation of a musical tone, to break the control data into data blocks, to generate a recovery data block for recovering the control data, to transmit the data block over a communication network, and likewise, to transmit the recovery data block over the communication network. Thus with this client-server structure, the control data for a musical instrument is distributed using a server, which enables an audience with a plurality of listeners to follow a concert, by generating a music from the MIDI data at each listener from the control data. Further, it is proposed to assign a consecutive sequence number to the individual packets of the MIDI data that retains the sequence of the packets, and makes it possible to reorder them after the transmission. This MIDI data also contains in its header the time data, which indicates the musical play time of the subsequent MIDI data. The play time of the music together with the information about the size of the MIDI data permits the music to be played at the intended speed.

From DE 101 46 887 A1, the entire contents of which is incorporated herein by reference, a method is known for synchronizing digital data streams with audio data on two or more data processing devices. For this, one of the data processing devices generates a control signal that describes an absolute time position in the data stream. With the known method, the data processing units are directly connected with each other over an ASIO interface.

From U.S. Pat. No. 6,175,872 B1, the entire contents of which is incorporated herein by reference, a system is known for the managing and synchronizing of MIDI data. The computers, which play the MIDI data exchanged through the network, are synchronized relative to a standard clock. For synchronizing the MIDI data, a timestamp with the absolute time plus a relative time delay is appended to a packet. The relative time delay arises from the position of the computer on which the data are intended to be played.

U.S. Pat. No. 6,067,566, the entire contents of which is incorporated herein by reference, relates to a method for playing of MIDI data streams while these are still being received. For this, it is proposed to provide a parser 207 and a time converter 209. The parser 207 reads event messages 117 and event data, which contain, in each case, details for the elapsed time (elapsed time descriptor 119). Here, the elapsed time refers to the beginning of a track (see column 5, lines 40-43). During play of files with several MIDI tracks, these are read in sequentially after one another. During playing of n-tracks, first, n−1 tracks are all received and saved. The saved tracks are played together with the not yet completely received track, when the track being played has reached the current position (SongPos 217) in the already saved tracks.

It is the technical object of the invention to provide a method with which the audio data from remote computers can be combined with precise timing.

### BRIEF SUMMARY OF THE INVENTION

The method relates to the playing and processing of audio data by at least two computers over a packet switching network. In the process, a peer-to-peer connection is created between the computers. With the method according to the invention, a first computer receives audio data, for example, from an instrument or a microphone via an audio input. The audio data of the first computer is assigned timestamps. A second computer, which is connected only over the data network with the first computer, is initialized for playing further audio data. The further audio data is similarly provided with timestamps. The audio data of the at least two computers is buffered in a storage, and using their timestamps, arranged such that it is possible to synchronously play the audio data. The method according to the invention permits audio data to be sent over a packet switched data network to a singer or musician, and for this to be played synchronized with other audio data. Through this, for example, during the recording and during the processing of the audio data, the participants can be located at separate locations, where despite the delay over the data network, the audio data can be played together synchronously. Consecutive sample numbers are provided as timestamps, and correspond to a starting time. The exact sample synchronization of the audio data creates a correlation in the range of 10 to 20 microseconds depending on the sampling rate in the audio data. The starting time is determined by the first computer. For this, the starting time of the audio data received from the computer is defined relative to the starting time in the further audio data. To be able to set the starting time exactly, a copy of the further audio data is located on the first computer. Possibly, it can also be provided that only a copy of the beginning of further data is present such that the audio data can be aligned sample exact with the further audio data. Preferably, the further audio data is located on the second computer, where it is then combined with the receipt of the audio data.

It has proven to be especially helpful, to record together with the audio data also information about the computer. This information can be used to help better coordinate the computers with each other.

The method according to the invention is not limited to one additional data stream, rather, according to the method according to the invention, multiple audio data can also be combined, for example, the instruments of a band or an orchestra.

In particular with singing and/or instruments, the microphone or the associated instruments are connected with the first computer, and the received audio data is recorded there after it has been supplied with timestamps. For this, it is especially advantageous, when the further data is also played in the first computer, while, at the same time the new audio data is being recorded. The audio data, which is transmitted with the method, can be present as audio, video, and/or MIDI data.

### BRIEF DESCRIPTION OF THE SEVERAL VIEWS OF THE DRAWINGS

The method according to the invention is explained in more detail in the following using an exemplary embodiment:

FIG. 1 shows the synchronization of two time shifted audio data.

FIG. 2 shows a principal configuration of an instance used with the method.

FIG. 3 shows the communication path created with a connection.

FIG. 4 shows a schematic view of the data exchange during the synchronization.

### DETAILED DESCRIPTION OF THE INVENTION

The present invention concerns a method for synchronization of audio data such that musicians using the method can contact each other over the Internet and can play music together other using a direct data connection. The collaboration occurs using a peer-to-peer connection with which the multiple musicians can collaborate, precisely timed.

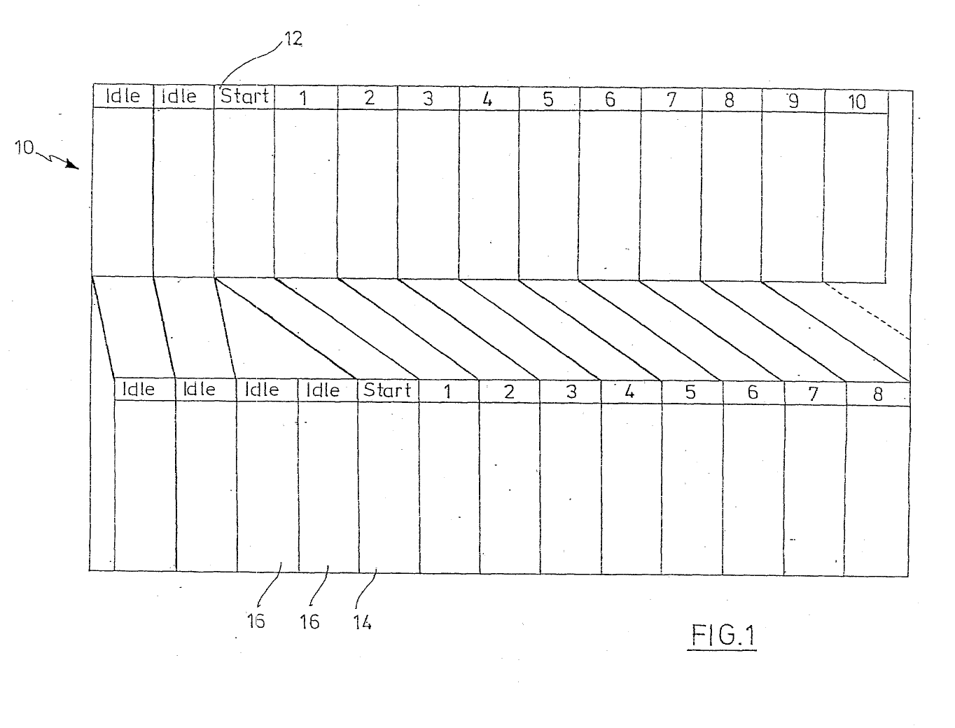

The central point of the collaboration is that the audio data of the participants are synchronized with each other. With the method, participant A puts his system into the play mode, this state is then transmitted to the second participant B. From this time hence, the data received by participant B is not further transferred directly for play, rather, it is buffered until participant B has also placed his system into the play state. FIG. 1 shows a time series 10, which corresponds to the data of the system A. At time 12, the system of participant B is switched to start. The system B further remains in the idle state and is only started with a start signal 14 at a later time instant 14. After the start signal 14, the individual samples are consecutively correlated with each other within a packet. After system B with the start signal 14 has also been placed in its play mode, the audio data is converted according to its time information synchronously to the time line from B, and is output. The precision during output corresponds approximately to a time resolution of a sample, thus, approximately 10 to 20 microseconds. The correlation of the data enables, for example, a musician and producer, although spatially separated, to work together within an authoring system, for example, on a digital audio workstation (DAW). With an appropriate transmission speed, recordings can also be performed specifically, in which a person annotates the received data. While the data is combined with the present audio data, with precise timing, due to the transmission, a delay of a few seconds occurs that still allows interactive work.

For a possible further development, the receiver B can also generate a control signal, from the received data, which it sends to a sequencer of system A to automatically start it. Then, system B is automatically started after A was started, and the two additional idle time steps 16 in FIG. 1 can be omitted.

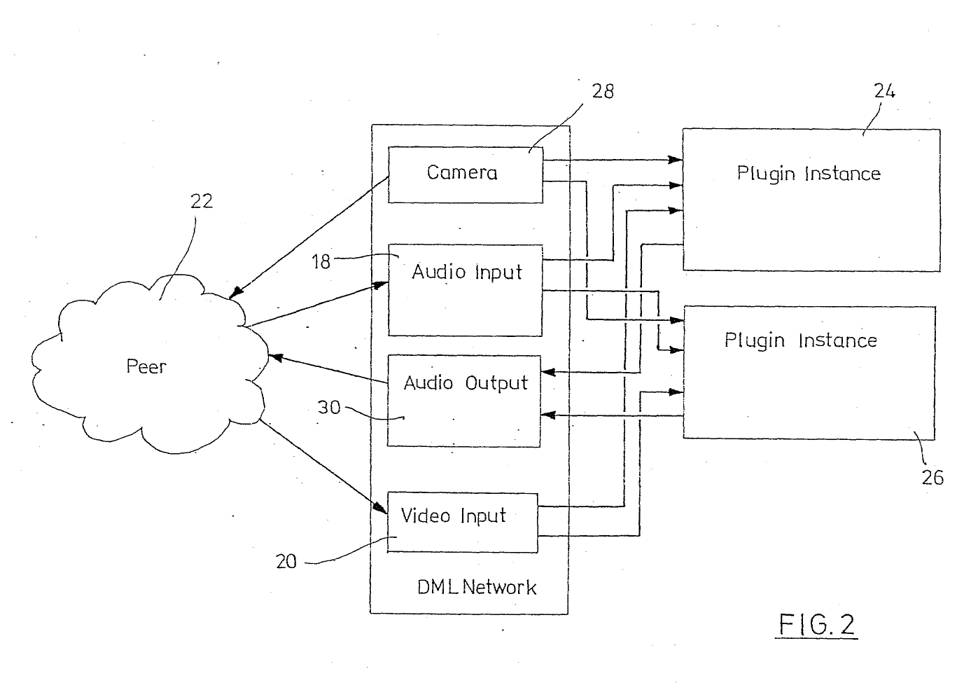

FIG. 2 shows a schematic design in a DML network (DML=digital musician link). As a first instance, an audio input 18 and a video input 20 are provided. Audio input 18 and video input 20 contain data from another participant 22 (peer). As shown in the exemplary embodiment in FIG. 2, the received input data is further transferred to two plug-in instances. Each instance can, for example, represent a track during the recording. The instances 24 and 26 draw on existing technology, for example, for the peer-to-peer communication. The audio data and the video data of the inputs are connected, respectively, to the instances 24 and 26. Additionally, video signals of a camera 26 are connected to the instances, which are similarly transmitted to the peer 22. Regarding the division of the bandwidth and the prioritization of the method according to the invention, audio data is transmitted with a higher priority than the video data. The audio output 30 is further transferred to a peer 22, where it is then synchronized as described in the preceding.

For coordination of the play in the system, it has proven helpful along with the audio data, and possibly video data, to also transfer data regarding the operating state of the system. As an example of this, whether a transport has started, or if currently the stop mode prevails. Further, additional information can be exchanged periodically between the participants, to be able to compensate possible differences in their systems.

Because the audio plug-in instances 24 and 26 are in general, inserted in the channels by a higher-level application, for example, a sequencer or a DAW, the example represented in FIG. 2 is configured such that multiple instances of the DML plug-in application can be created by the user, namely for each channel, from which the audio data is sent or from which the audio data is received.

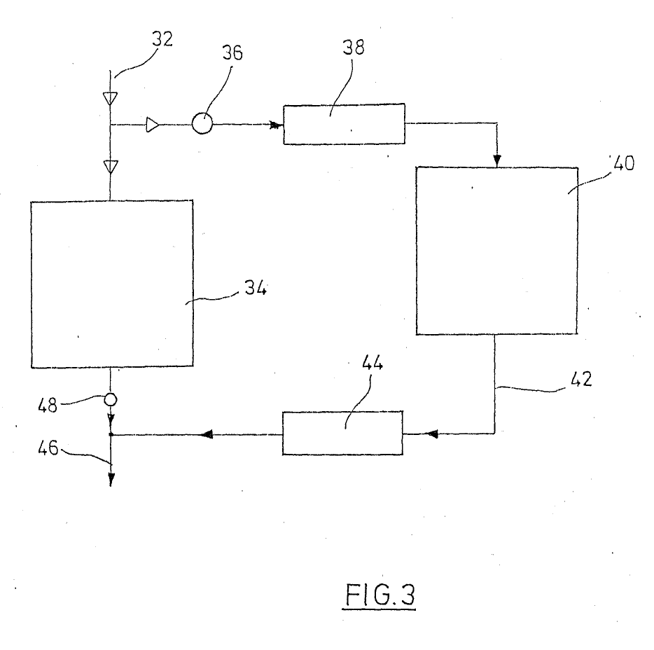

FIG. 3 shows an example for a user interface with one such plug-in instance. Represented in FIG. 3, the input data of a participant A are connected to the input 32. The input data, which for example, also contains video data, is rendered in 34 and played back. If using a selection 36, it is determined that the input data 32 is also to be sent, it is processed in the stage 38. The processed data is sent to the second participant, where this data is rendered as audio data or as audio and video data in the output unit 40. The audio data recorded by the second participant is sent as data 42 to the first participant and received using a unit 44. The data of the receiver unit 44 is combined with the recorded end data 32 and transferred further as output data 46. For synchronizing both data, the input data 32 is buffered until the associated data 42 is received.

The preceding sequence offers the possibility to suppress (mute on play) the sending of the data by a corresponding adjustment in 36. Through this, a type of “talkback” function is achieved, so that the producer can not be heard by the singer or musician during the recording, which due to the time delay can be disruptive. Using the selection 48 (THRU), the user can similarly adjust whether a sending channel itself can be heard. Alternatively, the input samples of the channel can be replaced by the received samples of the connected partners.

Thus, using the selection switch 48, it can be selected whether the originally recorded data 32 is to be directly played back unchanged, or whether this data is to be play back synchronized with the data of the second participant 40. If for example, it is selected using the selection switch 36 that the incoming audio data 32 is not to be sent, in stage 38 signals for synchronizing the play with, for example, video data, can still be created.

The concept represented in FIG. 2 provides that all plug-in instances 24 and 26 use a common object (DML network in FIG. 2). The common object combines all streams of sending plug-in instances, and sends these as a common stream. Similarly, the received data streams are further transferred to all receiving instances. The common object also fulfills a similar function regarding the video data, which is not combined, but rather sent from the camera as a data stream. The video data of the user is also further transferred to the respective plug-in instances.

The video data are basically synchronized like the audio data. That means, when both participants have started the transport system (see FIG. 3), the user who started last hears not only the audio data of the other participant(s) synchronized with his own time line, rather, he also sees the camera of the partner synchronized to his own time base, which is important, for example, for dance and ballet.

The method according to the invention is explained in the following using an example:

Computer A is used by a producer, and computer B is used by a singer. Both have an instance of the plug-in connected into their microphone input channel. Both send and receive (talkback), the producer has activated “mute on play” 36. In the idle state, A and B can talk to each other. Additionally, both already have an identical or a similar playback in their time line project of the higher-level application.

The singer starts to form the connection on his computer, and begins sing to his playback. On the side of the producer (computer A), the following takes place:
the data of his microphone channel is no longer sent (mute on play), so that the singer is not disrupted. The video image of the singer stands,
the producer no longer hears the singer,
audio and video data are saved with the received timestamps.

Now, the producer starts his sequencer on his side, as previously mentioned, this can also occur automatically. The sequencer of the producer now records, wherein the following holds true for the producer:

His microphone samples continue to be suppressed, because the singer in the meantime has advanced further. Only when the producer also removes “mute on play”, can he request, for example, to stop the recording. The producer hears the singer synchronized to the playback stored on his computer. Further, the video data is played back synchronized with the playback stored at the producer.

If, for example, an instrument takes the place of the singer, a second instance of the plug-in can be connected for this into the guitar channel. Then, a microphone channel would be provided for speech and talkback, which during the recording is likewise switched to “mute on play”, such that the producer hears only digitally during the recording. The guitar channel is defined using TRANSMIT.

In the implementation, the method according to the invention provides that, for example, a VMNAaudioPacket is defined. In the AudioPacket, the samplePosition is defined as a counter. The samplePosition indicates the current position of the time scale, when the method is not running. If the project is running, the samplePosition indicates the position of the packet relative to a running (continuously) counter. This running counter is defined using a specific start signal, wherein the counter is set to 0, when the packet counter is set to 0. Depending on the operating mode of the method, the position of the packet is calculated accordingly.

Including the data exchange for the synchronization of the data stream, the method is represented as follows:

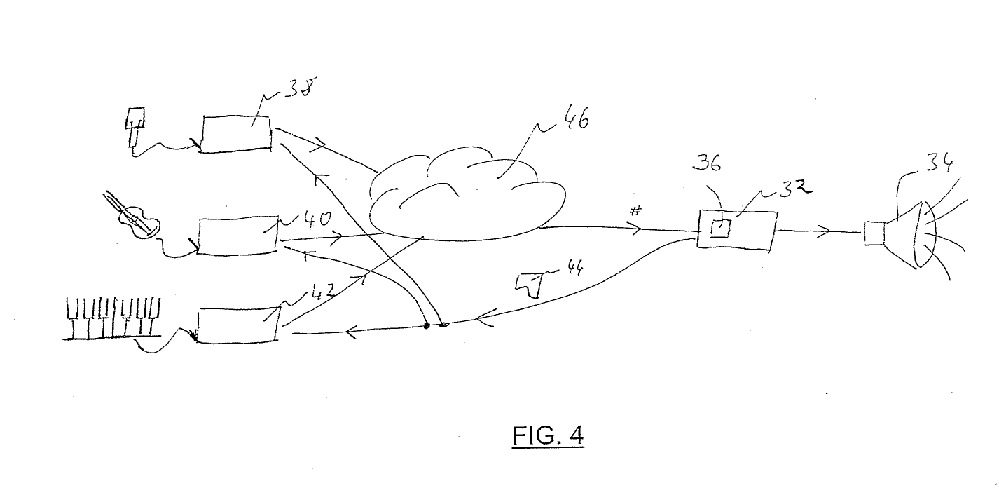

In FIG. 4, a computer 32 is represented, at which the synchronized audio data is output, for example, to a loudspeaker 34. The audio data to be output is combined with sample accuracy in a storage 36. The combined data originates from further computers 38, 40, and 42. Each of the represented computers is connected via an audio input with a microphone 44 or a musical instrument. The recorded audio data is provided with sample numbers and sent over the network 46 to the computer 32. For initializing the computers 38, 40, and 42 at the beginning, a data set, which is labeled as further audio data, is sent from the computer 32 to the computers 38, 40, and 42. The further audio data 44, which is possibly also sent only with the beginning of the audio data to the remaining computers, is present on the computers, over which the further audio data are played in. The start of this data defines the time origin, from which the sample number is counted. The further data 44 can be, for example, playback data. This data is played back on the computers 38, 40, and 42, the additionally recorded song or the musical sounds are then sent out using the data network 46. The received song is then again combined with sample accuracy in the computer 32 with the playback data. Through this method, a very exact correlation is achieved during playing of the data.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for playing and processing of audio data by at least two computers over a packet switching data network, wherein at least one first computer receives audio data via an audio input, and further transfers it to the second computer, the method has the following steps:
the audio data of the first computer is provided with consecutive sample numbers, which relate to the starting time, wherein the starting time is set by the first computer, in that a copy of the start of the further audio data is transmitted to the first computer, and the starting time of the audio data of the first computer is defined relative to the starting time of the further audio data;
a second computer is initialized for playing the further audio data, which is similarly provided with a consecutive sample number; and
the audio data of at the least two computers is buffered in a storage and correlated with each other using the sample numbers.

2. The method according to claim 1, characterized in that the further audio data is stored on the second computer.

3. The method according to claim 2, characterized in that the further audio data is sent from the first computer to the second computer.

4. The method according to claim 3, characterized in that information about the operating state of the computer is recorded with audio data.

5. The method according to claim 1, characterized in that audio data from more than two computers is combined.

6. The method according to claim 1, characterized in that on the computers sequencer software is provided that permits a processing of the audio data.

7. The method according to claim 1, characterized in that the first computer unit receives the audio data from a microphone and/or an instrument, which is connected with the computer.

8. The method according to claim 7, characterized in that the first computer plays the further audio data, which the audio data is received.
